(19) United States
(12) Patent Application Publication
(10) Pub. No.: US 2012/0159124 A1
(43) Pub. Date: Jun. 21, 2012

(54) METHOD AND SYSTEM FOR COMPUTATIONAL ACCELERATION OF SEISMIC DATA PROCESSING

(75) Inventors: Chaoshun Hu, Houston, TX (US); Yue Wang, Sugar Land, TX (US); Tamas Nemeth, San Ramon, CA (US)

(73) Assignee: Chevron U.S.A. Inc.

(21) Appl. No.: 12/969,337

(22) Filed: Dec. 15, 2010

(51) Int. Cl. G06F 9/30; G06F 9/312; G06F 12/08

(52) U.S. Cl. 712/205; 712/220; 711/119; 711/E12.017; 712/E09.016; 712/E09.033

(57) ABSTRACT

A computer-implemented method and a system for computational acceleration of seismic data processing are described. The method includes defining a specific non-uniform memory access (NUMA) scheduling for a plurality of cores in a processor according to data to be processed; and running two or more threads through each of the plurality of cores.

### BACKGROUND OF THE INVENTION

1. Field of the Invention

The present invention pertains in general to computation methods and more particularly to a computer system and computer-implemented method for computational acceleration of seismic data processing.

2. Discussion of Related Art

Seismic data processing including three-dimensional (3D) and four-dimensional (4D) seismic data processing and depth imaging applications are generally computer and time intensive due to the number of points involved in the calculation. For example, as many as a billion points (10⁹ points) can be used in a computation. Generally, the greater the number of points the greater is the period of time required to perform the calculation. The calculation time can be reduced by increasing computational resources, for example by using multi-processor computers or by performing the calculation in a networked distributed computing environment.

Over the past decades, increasing a central processing unit (CPU) speed is implemented to boost computer capability so as to meet computation requirement in seismic exploration. However, CPU speed reaches a limit and further improvement becomes increasingly difficult. Computing systems using multi-cores or multiprocessors are used to deliver unprecedented computational power. However, the performance gained by the use of multi-core processors is strongly dependent on software algorithms and implementation. Conventional geophysical applications do not realize large speedup factors due to lack of interaction or synergy between CPU processing power and parallelization of software.

The present invention addresses various issues relating to the above.

### BRIEF SUMMARY OF THE INVENTION

An aspect of the present invention is to provide a computer-implemented method for computational acceleration of seismic data processing. The method includes defining a specific non-uniform memory access (NUMA) scheduling for a plurality of cores in a processor according to data to be processed; and running two or more threads through each of the plurality of cores.

Another aspect of the present invention is to provide a system for computational acceleration of seismic data processing. The system includes a processor having a plurality of cores. A specific non-uniform memory access (NUMA) scheduling for the plurality of cores is defined according to data to be processed, and each of the plurality of cores is configured to run two or more of a plurality of threads.

Yet another aspect of the present invention is to provide a computer-implemented method for increasing processing speed in geophysical data computation. The method includes storing geophysical data in a computer readable memory; applying a geophysical process to the geophysical data for processing using a processor; defining a specific non-uniform memory access scheduling for a plurality of cores in the processor according to data to be processed by the processor; and running two or more threads through each of the plurality of cores.

Although the various steps of the method of providing are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a logical flow diagram of a method for computational acceleration of seismic data processing, according to an embodiment of the present invention;

FIG. 2 is a simplified schematic diagram of a typical architecture of a processor having a plurality of cores for implementing the method for computational acceleration of seismic data processing, according to an embodiment of the present invention;

FIG. 3 is a bar graph showing a runtime comparison between different methods of computing a two-dimensional tau-p transform over a typical dataset, according to an embodiment of the present invention;

FIG. 4A is a bar graph showing a runtime profile for a typical three-dimensional (3D) shot beamer on one dataset without acceleration, according to an embodiment of the present invention;

FIG. 4B is a bar graph showing the runtime profile for a typical 3D shot beamer on the same dataset but with acceleration, according to an embodiment of the present invention;

FIG. 5 is a bar graph showing a runtime comparison between different methods of computing a two-dimensional (2D) finite difference model, according to an embodiment of the present invention;

FIG. 6 is a schematic diagram representing a computer system for implementing the method, according to an embodiment of the present invention; and

FIG. 7 is a logical flow diagram of a computer-implemented method for increasing processing speed in geophysical data computation, according to an embodiment of the invention.

### DETAILED DESCRIPTION OF EMBODIMENTS OF THE INVENTION

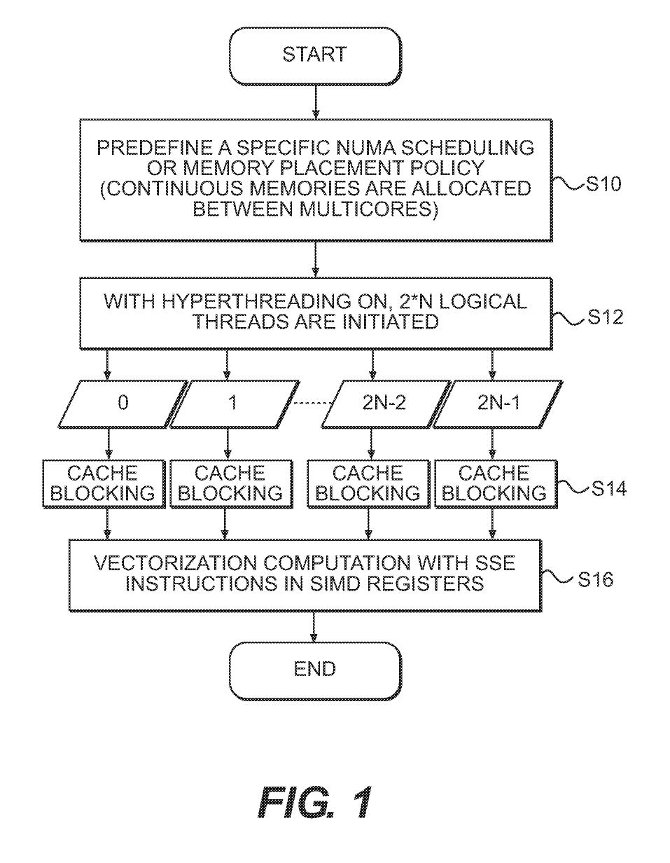

In order to accelerate seismic processing and imaging applications or other data intensive applications, different level of parallelism and optimized memory usage can be implemented. FIG. 1 is a logical flow diagram of the method for computational acceleration of seismic data processing, according to an embodiment of the present invention. The method includes defining a specific non-uniform memory access (NUMA) scheduling or memory placement policy for a plurality of cores in a processor according to data (e.g., size of data, type of data, etc.) to be processed, at S10. In a multi-core architecture, NUMA provides memory assignment for each core to prevent a decline in performance when several cores attempt to address the same memory.

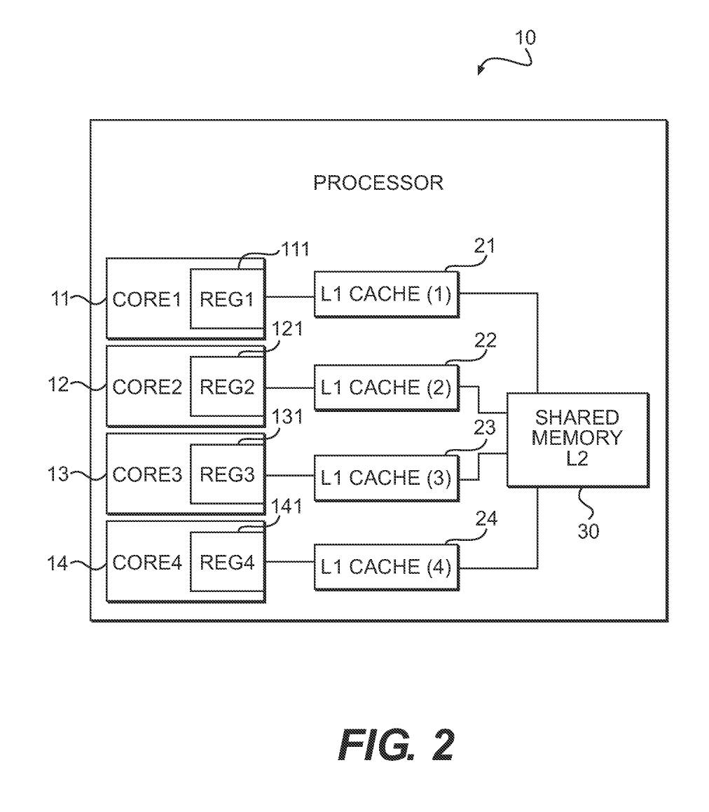

FIG. 2 is a simplified schematic diagram of a typical architecture of a processor having a plurality of cores, according to an embodiment of the present invention. As shown in FIG. 2, a processor 10 may have a plurality of cores, for example, 4 cores. Each core has registers. For example, core1 11 has registers REG1 121, core2 12 has registers REG2 121, core3 13 has registers REG3 131, and core4 14 has registers REG4 141. Each core is associated with a cache memory. For example, core1 11 is associated with level one (L1) cache memory (1) 21, core2 12 is associated with level one (L1) cache memory (2) 22, core3 13 is associated with level one (L1) cache memory (3) 23, and core4 14 is associated with level one (L1) cache memory (4) 24. In addition, each or the cores (core1, core2, core3, core4) has access to a level 2 (L2) shared memory 30. Although, the shared memory 30 is depicted herein as being a L2 shared memory, as it can be appreciated, the shared memory can be at any desired level L2, L3, etc.

A cache memory is used by a core to reduce the average time to access main memory. The cache memory is a faster memory which stores copies of the data from the most frequently used main memory locations. When a core needs to read from or write to a location in main memory, the core first checks whether a copy of that data is in the cache memory. If a copy of the data is stored in the cache memory, the core reads from or writes to the cache memory, which is faster than reading from or writing to main memory. Most cores have at least three independent caches which include an instruction cache to speed up executable instruction fetch, a data cache to speed up data fetch and store, and a translation look aside buffer used to speed up virtual-to-physical address translation for both executable instructions and data.

For instance, in the example shown in FIG. 2, NUMA provides that for each core (e.g., core1, core2, etc.) a specific size of cache memory is allocated or provided to each core to prevent a decline in performance for that core when several cores attempt to address one cache memory (e.g. shared cache memory). In addition, NUMA enabled processor systems may also include additional hardware or software to move data between cache memory banks. For example, in the embodiment shown in FIG. 2, a specific predefined NUMA may move data between cache memory (1) 21, cache memory (2) 22, cache memory (3) 23, and cache memory (4) 24. This operation has the effect of providing data to a core that is requesting data for processing thus substantially reducing or preventing data starvation of the core and hence providing an overall speed increase due to NUMA. In NUMA, special-purpose hardware may be used to maintain cache coherence identified as “cache-coherent NUMA” (ccNUMA).

As shown in FIG. 1, the method further includes initiating a plurality of threads with hyper-threading, and running one or more threads on through each core in the plurality of cores, at S12. In one embodiment, each core (e.g., core1, core2, core3 and core4) is assigned two or more threads which are run on the core. In one embodiment, cache memories allocated to various cores can be accessed continuously between different threads. When two logical threads are run on the same core, these two threads share the cache memory allocated to the particular core through which the threads are run. For example, when two logical threads run on core1 11, these two logical threads share the same cache memory (1) 21 associated with or allocated to core1 11. In this case, if there are N cores, 2N logical threads can be run through the N cores, each core being capable of running 2 threads. For example, if the first thread is numbered 0, the next thread is numbered 1, the last thread is numbered 2N−1, as shown in FIG. 1.

In one embodiment, the hyper-threading is implemented in new generation high-performance computing (HPC) machines such as Nehalem (e.g., using core i7 family) and Westmere (e.g., using core i3, i5 and i7 family) micro-architecture of Intel Corporation. Although, the hyper-threading process is described herein being implemented on a type of CPU family, the method described herein is not limited in any way to these examples of CPUs but can be implemented on any type of CPU architecture including, but not limited to, CPUs manufactured by Advanced Micro Devices (AMD) Corporation, Motorola Corporation, or Sun Microsystems Corporation, etc.

Because a geophysical dataset contains a very large number of data points and not enough fast cache memory is available to fill with data, the method further includes cache blocking the data among the cache memories allocated to the plurality of cores to divide the whole dataset into small data chunks or blocks, at S14. In one embodiment, a block of data fits within a cache memory allocated to a core. For example, in one embodiment, a first block of data fits into cache memory (1) 21, a second block of data fits into cache memory (2) 22, a third block of data fits into cache memory (3) 23, and a fourth block of data fits into cache memory (4) 24. In another embodiment, one or more data blocks can be assigned to one core. For example, two, three or more data blocks can be assigned to core1 11. In which case, core1 11 will be associated with two, three or more cache memories instead of one cache memory. In one embodiment, cache blocking restructures frequent operations on a large data array by sub-dividing the large data array into smaller data blocks or arrays. Each data point within the data array is provided within one block of data.

The method further includes loading the plurality of data blocks into a plurality of single instruction multiple data (SIMD) registers (e.g., REG1 111 in core1 11, REG2 121 in core2 12, REG3 131 in core3 13 and REG4 141 in core4 14), at S16. Each data block is loaded into SIMD registers of one core. In SIMD, one operation or instruction (e.g., addition, subtraction, etc.) is applied to each block of data in one operation. In one embodiment, streaming SIMD extensions (SSE) which is a set of SIMD instructions to the x86 architecture designed by Intel Corporation are applied to the data blocks so as to run the data-level vectorization computation. Different threads can be run with OpenMPI or with POSIX Threads (Pthreads).

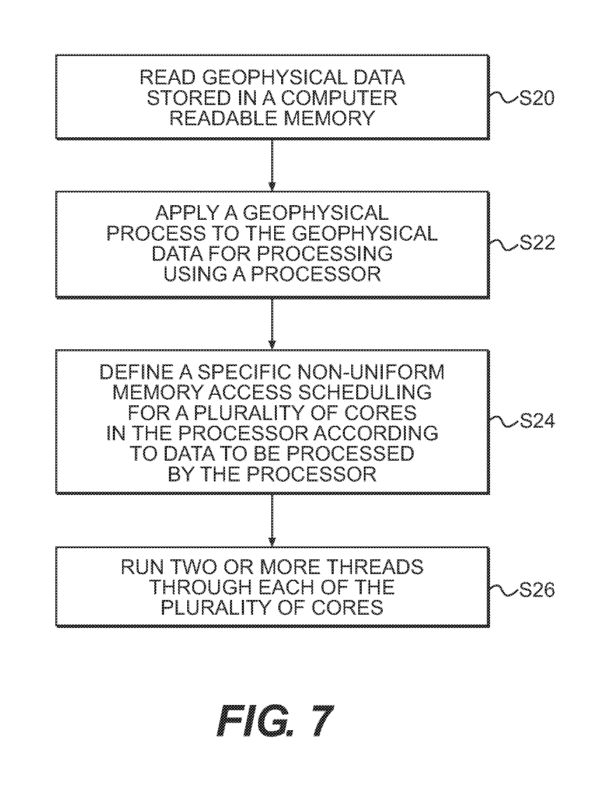

FIG. 7 is a logical flow diagram of a computer-implemented method for increasing processing speed in geophysical data computation, according to an embodiment of the invention. The method includes reading geophysical data stored in a computer readable memory, at S20. The method further includes applying a geophysical process to the geophysical data for processing using a processor, at S22. The method also includes defining a specific non-uniform memory access scheduling for a plurality of cores in the processor according to data to be processed by the processor, at S24, and running two or more threads through each of the plurality of cores, at S26.

Seismic data processing and imaging applications using a multi-core platform poses numerous challenges. A first challenge may be in the temporal data dependence. Indeed, the geophysical process may include a temporarily data dependent process. A temporarily data dependent process comprises a time-domain tau-p transform process, a time-domain radon transform, time-domain data processing and imaging, or any combination of two or more these processes. A tau-p transform is a transformation from a space-time domain into wavenumber-shifted time domain. Tau-p transform can be used for noise filtering in seismic data. A second challenge may be in spatial stencil or spatial data dependent computation. Indeed, the geophysical process may also include a spatial data dependent process. The spatial data dependent process includes a partial differential equation process (e.g., finite-difference modeling), ordinary differential equation (e.g., an eikonal solver), reservoir numerical simulation, or any combination of two or more of these processes.

In one embodiment, to tackle the first challenge and perform the Tau-p computation, for example, several copies of the original input datasets are generated and reorganized. The different data copies can be combined. In order to minimize memory access latency and missing data, the method includes cache blocking the data by dividing into a plurality of blocks of data. In one embodiment, the data is divided into data blocks and fetched into a L1/L2 cache memory for fast access. The data blocks are then transmitted or transferred via a pipeline technique to assigned SIMD registers to achieve SIMD computation and hence accelerating the overall data processing.

In one embodiment, to tackle the second challenge and perform the stencil computation, data are reorganized to take full advantage of memory hierarchies. First, the entire data set (e.g., provided in three dimension) is partitioned into smaller data blocks. By partitioning into smaller data blocks (i.e., by cache blocking), different levels of cache memory (for example, L3 cache) capacity misses can be prevented.

Furthermore, in one embodiment, each data block can be further partitioned into a series of thread blocks so as to run through a single thread block (each thread block can be dedicated to one thread). By further partitioning each block into a series of thread blocks, each thread can fully exploit the locality within the shared cache or local memory. For example, in the case discussed above where two threads are runs through one core (e.g., core1 11), the cache memory 21 associated with this core (core1 11) can be further portioned or divided into two thread blocks wherein each thread block is dedicated to one of the two threads.

Additionally, in another embodiment, each thread block can be decomposed into register blocks and processing the register blocks using SIMD through a plurality of registers with each core. By decomposing each thread block into register blocks, data-level parallelism SIMD may be used. For each computation step (e.g., mathematical operation), the input and output grids or points are each individually allocated as one large array. Since NUMA system considers a “first touch” page mapping policy, parallel initialization routine to initialize the data is used. The use of “first touch” page mapping policy enables allocating memory close to the thread which initializes the memory. In other words, memory is allocated on a node close to the node containing the core on which the thread is running. Each data point is correctly assigned to a thread block. In one embodiment, when using NUMA aware allocation, the speed computation performance is approximately doubled.

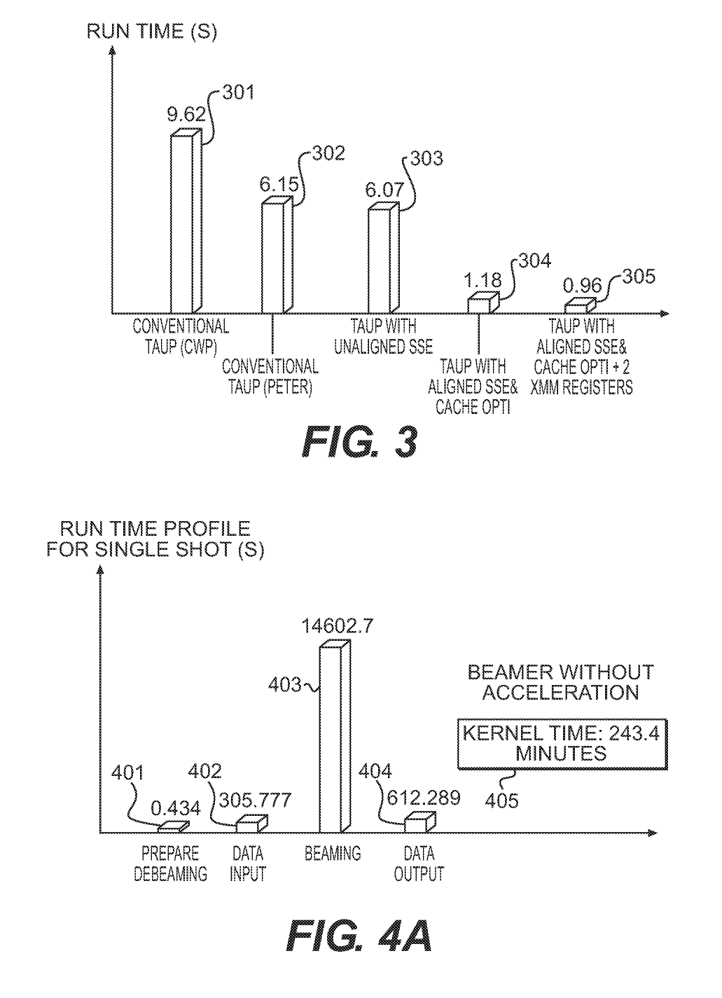

FIG. 3 is a bar graph showing a runtime comparison between different methods of computing a two-dimensional tau-p transform over a typical dataset, according to an embodiment of the present invention. The ordinate axis represents the time in seconds it took to accomplish the two-dimensional tau-p transform. On the abscissa axis are reported the various methods used to accomplish the two-dimensional tau-p transform. The first bar 301 labeled “conventional tau-p (CWP)” indicates the time it took to run the two-dimensional tau-p transform using the conventional method developed by the Center for Wave Phenomenon (CWP) at the Colorado School of Mines. The conventional tau-p (CWP) method performs the tau-p computation in about 9.62 seconds. The second bar 302 labeled “conventional tau-p (Peter)” indicates the time it took to run the two-dimensional tau-p transform using the conventional method from Chevron Corporation. The conventional tau-p (Peter) method performs the tau-p computation in about 6.15 seconds. The third bar 303 labeled “tau-p with unaligned SSE” indicates the time it took to run the two-dimensional tau-p transform using the method unaligned streaming SIMD extensions (SSE) according to one embodiment of the present invention. The unaligned SSE method performs the tau-p computation in about 6.07 seconds. The fourth bar 304 labeled “tau-p with aligned SSE and cache optimization” indicates the time it took to run the two-dimensional tau-p transform using the method aligned SSE and cache optimization according to another embodiment of the present invention. The aligned SSE with cache optimization method performs the tau-p computation in about 1.18 seconds. The fifth bar 305 labeled “tau-p with aligned SSE and cache optimization+XMM registers pipeline” indicates the time it took to run the two-dimensional tau-p transform using the method aligned SSE with cache optimization and with two XMM registers pipeline (i.e., using SIMD) according to yet another embodiment of the present invention. The aligned SSE with cache optimization and two XMM registers method performs the tau-p computation in about 0.96 seconds. As shown in FIG. 3, by using aligned SSE and cache optimization, the speed of tau-p computation is increased by a factor of about 6 from the unaligned SSE method. Furthermore, the speed of the computation is further increased by using aligned SSE with cache optimization with two XMM registers pipeline. Indeed, a speed up factor of about 10 is achieved between the conventional method and the aligned SSE with cache optimization and two XMM registers according to an embodiment of the present invention.

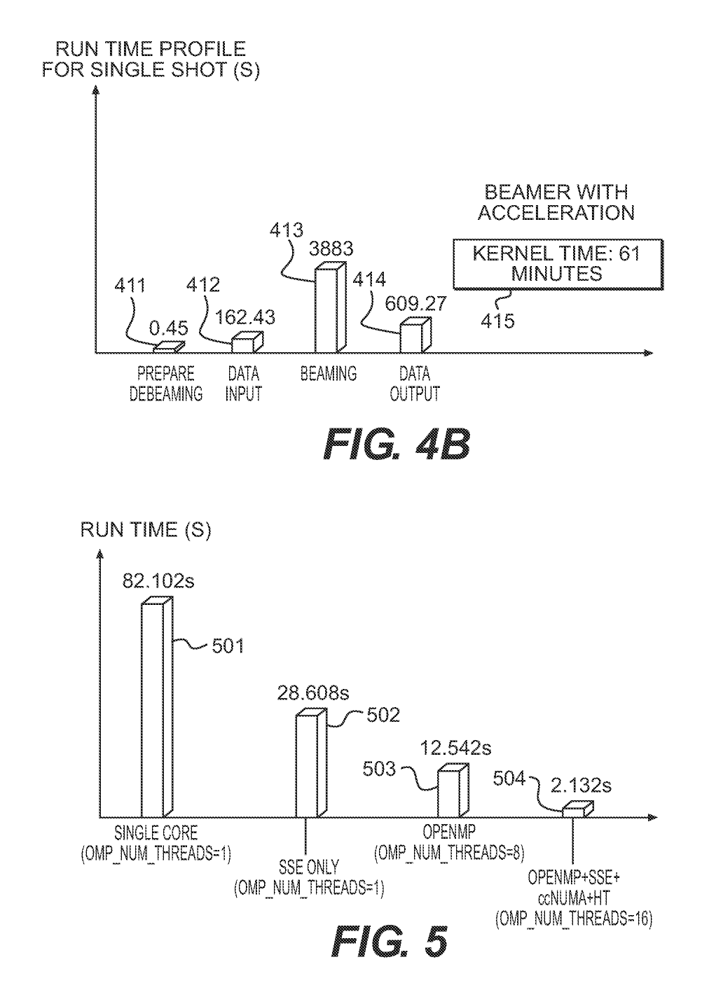

FIG. 4A is a bar graph showing the runtime profile for a typical 3D shot beamer on one dataset without acceleration. A beamer is conventional method used in seismic data processing. The ordinate axis represents the time it took in seconds to accomplish the various steps in the beamer method. On the abscissa axis are reported the various steps used to accomplish the two-dimensional tau-p transform. FIG. 4A, shows that the runtime 401 to prepare debeaming is about 0.434 seconds, the runtime 402 to input the data is about 305.777 seconds, the runtime 403 to perform the beaming operation is about 14602.7 seconds, and the runtime 404 to output the data is about 612.287 seconds. The total runtime 405 to perform the beamer method is about 243.4 minutes.

FIG. 4B is a bar graph showing the runtime profile for a typical 3D shot beamer on the same dataset but with acceleration. In this case, the same beamer method is used on the same set of data but using SSE and cache blocking without 2 MMX registers pipeline acceleration, according to one embodiment of the present invention. The ordinate axis represents the time it took in seconds to accomplish the various steps in the beamer method. On the abscissa axis are reported the various steps used to accomplish the data processing step. FIG. 4B, shows that the runtime 411 to prepare debeaming in this case is about 0.45 seconds, the runtime 412 to input the data is about 162.43 seconds, the runtime 413 to perform the beaming operation is about 3883 seconds, and the runtime 414 to output the data is about 609.27 seconds. The total run time 415 to perform the beamer method with the accelerated method is about 61 minutes. Therefore, a speed up of the overall computation is realized by a rate of approximately 4 (243 minutes/61 minutes). The processing speed of the beaming operation is increased by a factor of about 4.

FIG. 5 is a bar graph showing a runtime comparison between different methods of computing a two-dimensional finite difference modeling, according to an embodiment of the present invention. The ordinate axis represents the runtime in seconds it took to accomplish the two-dimensional finite difference computation. On the abscissa axis are reported the various methods used to accomplish the two-dimensional finite difference modeling. The first bar 501 labeled “single core (OMP-NUM-THREADS=1)” indicates the time it took to run the two-dimensional finite difference computation using a conventional single core processor. The conventional method using the single core and one thread performs the finite difference computation in about 82.102 seconds. The second bar 502 labeled “SSE only (OMP-NUM-THREADS=1)” indicates the time it took to run the two-dimensional finite difference computation using the SSE method but running one thread per core. This method performs the finite difference computation in 28.608 seconds. The third bar 503 labeled “opemMP (OMP_NUM_THREADS=8” indicates the time it took to run the two-dimensional finite difference computation using openMP running 8 threads per core, according to one embodiment of the present invention. This method performs the finite difference computation in about 12.542 seconds. The fourth bar 504 labeled “openMPP+SSE+ccNUMA+HT (OMP_NUM_THREADS=16)” indicates the time it took to run the two-dimensional finite difference computation using openMP along with SSE and ccNUMA and hyperthreading (HT) running 16 threads per core, according to another embodiment of the present invention. This method performs the finite difference computation in about 2.132 seconds.

As shown in FIG. 5, by using a conventional method (with one single core and running one thread per core) the runtime is about 82 seconds. With a method using SSE, cache blocking, hyperthreading (HT) and NUMA-aware memory access, the runtime is decreased to about 2.132 sec. A speed up factor of about 40 can be achieved.

In one embodiment, the method is implemented as a series of instructions which can be executed by a processing device within a computer. As it can be appreciated, the term “computer” is used herein to encompass any type of computing system or device including a personal computer (e.g., a desktop computer, a laptop computer, or any other handheld computing device), or a mainframe computer (e.g., an IBM mainframe).

For example, the method may be implemented as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media. The program application can be used to program and control the operation of one or more CPU having multiple cores.

Alternatively, a portion or the whole software program product can be downloaded from a remote computer or server via a network such as the internet, an ATM network, a wide area network (WAN) or a local area network.

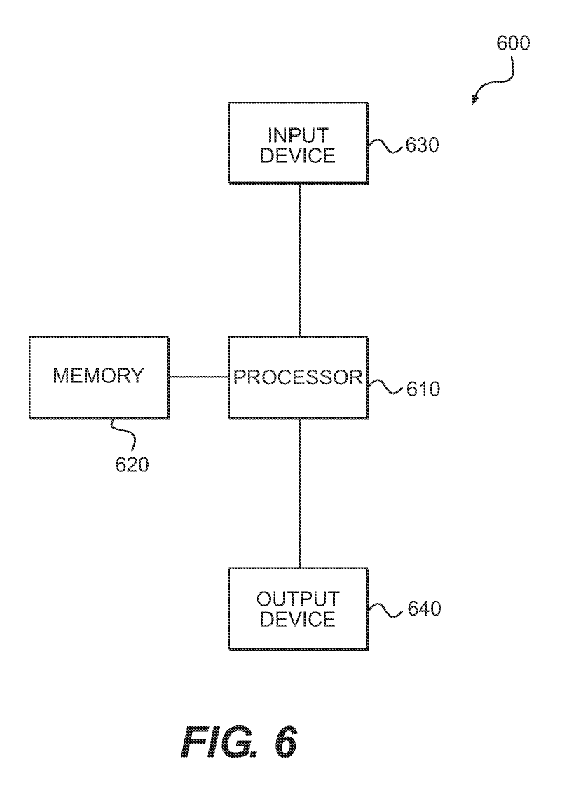

FIG. 6 is a schematic diagram representing a computer system 10 for implementing the method, according to an embodiment of the present invention. As shown in FIG. 2, computer system 600 comprises a processor (having a plurality of cores) 610, such as the processor depicted in FIG. 2, and a memory 620 in communication with the processor 610. The computer system 600 may further include an input device 630 for inputting data (such as keyboard, a mouse, or another processor) and an output device 640 such as a display device for displaying results of the computation.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A computer-implemented method for computational acceleration of seismic data processing, comprising:
defining a specific non-uniform memory access (NUMA) scheduling for a plurality of cores in a processor according to data to be processed; and
running two or more threads through each of the plurality of cores.

2. The method according to claim 1, wherein defining the specific non-uniform memory access includes allocating a plurality of cache memories to the plurality of cores by allocating at least one cache memory to each of the plurality of cores.

3. The method according to claim 2, wherein the two or more threads running through each core share the at least one cache memory allocated to said each core.

4. The method according to claim 2, further comprising dividing the data into data blocks among the plurality of cache memories allocated to the plurality of cores.

5. The method according to claim 4, wherein each data block fits into the at least one cache memory allocated to each of the plurality of cores.

6. The method according to claim 5, further comprising loading each data block into a plurality of single instruction multiple data (SIMD) registers provided within each of the plurality of cores.

7. The method according to claim 6, further comprising applying single instruction multiple data (SIMD) instruction to each data block in one operation.

8. The method according to claim 4, further comprising partitioning each data block into a plurality of thread blocks so that each thread block is dedicated to one thread.

9. The method according to claim 8, further comprising decomposing each thread block into a plurality of register blocks, and processing the register blocks using single instruction multiple data (SIMD) through a plurality of registers within each core.

10. A computer program product comprising a computer readable medium having instructions stored thereon when executed by a computer performs the method recited in claim 1.

11. A system for computational acceleration of seismic data processing, comprising:
a processor comprising a plurality of cores, wherein a specific non-uniform memory access (NUMA) scheduling for the plurality of cores is defined according to data to be processed, and wherein each of the plurality of cores is configured to run two or more of a plurality of threads.

12. The system of claim 11, further comprising a plurality of cache memories allocated to the plurality of cores, wherein at least one cache memory is allocated to each of the plurality of cores.

13. The system according to claim 12, wherein the two or more threads running through each core share the at least one cache memory allocated to said each core.

14. A computer-implemented method for increasing processing speed in geophysical data computation, comprising:
reading geophysical data stored in a computer readable memory;
applying a geophysical process to the geophysical data for processing using a processor;
defining a specific non-uniform memory access scheduling for a plurality of cores in the processor according to data to be processed by the processor; and
running two or more threads through each of the plurality of cores.

15. The method according to claim 14, wherein the geophysical process comprises a temporarily data dependent process.

16. The method according to claim 15, wherein the temporarily data dependent process comprises a time-domain tau-p transform process, a time-domain radon transform, time-domain data processing and imaging, or any combination of two or more thereof.

17. The method according to claim 14, wherein the geophysical process comprises a spatial data dependent process.

18. The method according to claim 17, wherein the spatial data dependent process comprises a partial differential equation process, ordinary differential equation, reservoir numerical simulation, or any combination of two or more thereof.

19. The method according to claim 18, wherein the partial differential equation process comprises finite-difference modeling.

20. The method according to claim 18, wherein the ordinary differential equation process comprises an eikonal solver.
